(19) United States
(12) Patent Application Publication
(10) Pub. No.: US 2025/0356641 A1
(43) Pub. Date: Nov. 20, 2025

(54) COARSE PREDICTION DRIVEN CONTEXT ENHANCEMENT FOR JOINT MULTI-MODAL SENSOR REPRESENTATION LEARNING

(71) Applicant: Qualcomm Incorporated, San Diego, CA (US)

(72) Inventors: Varun RAVI KUMAR, San Diego, CA (US); Chiranjib CHOUDHURI, Bangalore (IN); Senthil Kumar YOGAMANI, Galway (IE)

(21) Appl. No.: 18/666,330

(22) Filed: May 16, 2024

(51) Int. Cl. G06V 10/80; G06V 10/34; G06V 10/44; G06V 20/58

(52) U.S. Cl. CPC G06V 10/803; G06V 10/34; G06V 10/44; G06V 20/58

(57) ABSTRACT

Certain aspects of the present disclosure provide techniques for coarse-to-fine attention-based sensor fusion. The method includes obtaining a 3D voxel image space of an environment, the 3D voxel image space comprising first features of the environment extracted from a plurality of images; obtaining a point cloud corresponding to the environment, the point cloud comprising points, wherein the points are labeled with second features; generating a coarse representation of the environment, the coarse representation comprising a projection of the first features onto the points of the point cloud, wherein the projection is based on combining a respective set of the first features within a first radius from a point with a respective set of the second features corresponding to the point; applying a deformable attention module to predict fine sampling locations and extract fine features from the first features; and generating, with an attention module, a fine representation of the environment.

### INTRODUCTION

### Field of the Disclosure

Aspects of the present disclosure relate to multiple sensor fusion techniques, and more particularly to techniques for coarse-to-fine attention-based multiple sensor fusion.

### DESCRIPTION OF RELATED ART

Apparatuses, such as robots, autonomous vehicles, or the like, include sensors, such as image sensors (e.g., cameras), light detection and ranging equipment, radio detection and ranging equipment, SONAR sensors, or the like. The apparatuses may include autonomous driving perception systems that rely on fusion of data from multiple sensors. Fusion of data from multiple sensors addresses issues such as data sparsity, modality differences, and sensor limitations. For example, sensors such as light detection and ranging equipment and radio detection and ranging equipment generate sparse amounts of data compared to other sensors such as image sensors. Additionally, sensors such as image sensors can provide rich semantic information but suffer from occlusion and poor night performance. Conversely, sensors such as light detection and ranging equipment and radio detection and ranging equipment can detect objects in many conditions, for example, regardless of weather and darkness, but may only do so with sparse location data.

Accordingly, there exists a need to develop a perception solution that can reliably detect objects and the environment using affordable sensors like cameras and radio detection and ranging equipments. This would make use cases like autonomous driving more commercially viable and reduce the computational costs involved in current fusion processes.

### SUMMARY

One aspect provides a method that includes obtaining a 3D voxel image space of an environment, the 3D voxel image space comprising first features of the environment extracted from a plurality of images; obtaining a point cloud corresponding to the environment, the point cloud comprising points, wherein the points are respectively labeled with second features; generating a coarse representation of the environment, the coarse representation comprising a projection of the first features onto the points of the point cloud, wherein the projection is based on, for each of a first plurality of points in the point cloud, combining a respective set of the first features within a first radius from a point with a respective set of the second features corresponding to the point; applying a deformable attention module to the coarse representation, guided by positional encodings corresponding to the first plurality of points, to predict fine sampling locations and extract fine features from the first features; and generating, with an attention module, a fine representation of the environment, the fine representation comprising a fusion of the fine features and the coarse representation.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an illustrative image-based view of an environment based on a plurality of images from one or more imaging sensors.

FIG. 2 depicts an illustrative frame of point cloud data of the environment based on one or more sensors.

FIG. 3 depicts an illustrative sensor and computing system configured to implement coarse-to-fine sensor fusion processes described herein.

FIG. 4 depicts an illustrative framework of a coarse-to-fine fusion network.

FIG. 5 depicts an illustrative projection of the first features from voxels in the 3D voxel image space into the point cloud.

FIG. 6 depicts an illustrative block diagram of an example artificial neural network (ANN) according to examples of the present disclosure.

FIG. 7 depicts an example method for coarse-to-fine attention-based multiple sensor fusion.

FIG. 8 depicts an example apparatus.

### DETAILED DESCRIPTION

Aspects of the present disclosure provide apparatuses, methods, processing systems, and computer-readable mediums for coarse-to-fine attention-based multiple sensor fusion (e.g., also referred to herein as a coarse-to-fine fusion network).

As will be appreciated from the description of the coarse-to-fine fusion network and corresponding coarse-to-fine fusion mechanisms, fusing data from image sensors and other sensors such as light detection and ranging equipment or radio detection and ranging equipment can overcome individual sensor limitations. Current processes of fusing data at the point-pixel level requires extensive preprocessing to align different modalities. However, this can be computationally expensive and can introduce errors during alignment. Additionally, fusing extracted features from individual sensors late in a fusion pipeline does not fully leverage cross-modal correlations. In certain current fusion processes, sensors are often processed independently first before fusing results. In certain current fusion processes, fusion modules are added post-hoc. Likewise, many fusion approaches heavily rely on dense light detection and ranging equipment point clouds for fusion. This limits their applicability in situations with sparse or no Light detection and ranging equipment data. In certain fusion processes, hard-coded fusion strategies like concatenation or averaging may be utilized, but they cannot capture complex sensor relationships learned from data. Furthermore, sensor bias can arise in some fusion processes. More generally, current fusion processes suffer from issues like high computational cost, loss of spatial context, over-dependence on light detection and ranging equipment, sub-optimal fusion strategies and limited multi-sensor data for training deep models.

Aspects described herein provide techniques that use a coarse-to-fine training paradigm where sparse radio detection and ranging equipment detections may be first used to sample coarse predictions. For example, features from image data may be projected to the radio detection and ranging equipment domain and fused with radio detection and ranging equipment features using an attention module. Features from the image data may be obtained using a first machine learning model. Additionally, features identified in the radio detection and ranging equipment detections (e.g., a point cloud) may be obtained using a second machine learning model. During inference, coarse predictions can be obtained by dynamically sampling points based on the camera and radio detection and ranging equipment. These coarse predictions are then refined using a deformable attention module, for example a 3D ConvNet that applies deformable attention, to predict fine sampling locations from the coarse features. Deformable attention is an attention module used in deformable DETR (detection transformer) to architecture. Deformable attention utilizes a set of sampling points (e.g., fine sampling) around a reference point (e.g., a coarse prediction) as a pre-filter for prominent key elements out of all the feature points or pixels. Features from both modalities may be fused at these locations. Such techniques may allow a machine learning (ML) model using such an attention module to learn joint representations from camera and radio detection and ranging equipment in an end-to-end manner without relying on fixed fusion rules or neighborhoods. In certain aspects, such techniques may achieve robust object detection and segmentation from sparse sensor inputs.

Certain aspects described herein are discussed with reference to fusing image data from one or more cameras and point cloud data from one or more radio detection and ranging equipments. However, it should be understood that point cloud data may be obtained from other sensors such as light detection and ranging equipment or SONAR.

As will be described in more detail herein, certain aspects include coarse-to-fine attention mechanisms that dynamically sample coarse predictions based on radio detection and ranging equipment detections and their neighbors during the coarse-pass to form a coarse representation of the environment. The coarse representation of the environment refers to a fusion of the features from each of the multiple modalities. Subsequently, the coarse representation may be refined using features from both camera and radio detection and ranging equipment modalities during a fine pass. In certain aspects, such coarse-to-fine attention mechanisms may provide a technical advantage of the enablement of more effective and context-aware object detection and environment perception, such as compared to traditional fixed-resolution approaches.

In some cases, fusion of two or more modalities, such as the fusion of features obtained from image data and features obtained from point cloud data may overcome individual sensor limitations and provide robust, low-cost perception. In certain aspects, by jointly learning representations through multi-modal fusion, certain coarse-to-fine attention mechanisms described herein may achieve performance comparable to light detection and ranging equipment systems while generalizing to new environments with limited data. This may represent a significant departure from traditional single-sensor or fixed fusion rule approaches.

Certain aspects include an iterative coarse-fine training process that encourages joint representations learning from different views of the same situations, such as in scenarios with sparse or no light detection and ranging equipment data. In certain aspects, an iterative training process, combined with modality feature sharing and end-to-end optimization, may enable the fusion module, such as one or more machine learning models such as an artificial neural network (ANN) to effectively learn from both camera and radio detection and ranging equipment inputs, imparting knowledge from one modality to the other.

In certain aspects, a component of the coarse-to-fine attention mechanisms described herein include leveraging deformable attention to dynamically predict fine sampling locations based on coarse features, without relying on fixed fusion rules or neighborhoods. In certain aspects, such techniques provide the technical advantage of being able to effectively predict fine sampling locations and fuse features at multiple scales, providing more adaptive and context-aware perception compared to traditional fixed methods. As will be appreciated in more detail herein, certain aspects may provide techniques for coarse predictions during inference, including dynamic sampling, leveraging camera data, maintaining a history of radio detection and ranging equipment detections, training a policy network, and/or performing multiple coarse passes with different sampling strategies. The coarse-to-fine attention mechanisms, for example, with the implementation of an attention module, generate a fine representation of the environment. The fine representation may be a fusion of the fine features and the coarse representation such that a dense representation of the environment is formed from features of each sensor modality.

In certain aspects, an end-to-end trainable model enabling robust object detection or segmentation from the camera and radio detection and ranging equipment data is provided. The model leverages sparse 3D representation, for example, in a shared bird's eye view space of the environment, for fusion without pre-processing or aggregation of modalities. Dense feature data obtained from camera data having a first coordinate system is projected into sparse point cloud having a second coordinate system. The first and second coordinate system may be related based on a calibration of the sensors, for example, corresponding to their positioning on a vehicle deploying the sensors. However, the calibration of the sensors may be subject to many factors which may lead to inaccurate or degradation of alignment over time. Factors may include mechanical forces that change to position of one or more of the sensors such that the coordinate system of one system no longer aligns with a coordinate system of another system. For example, alignment of a first coordinate system of one system with a second coordinate system of another system may be defined by one or more rotation, translation, reflection, and/or dilation transformation parameters. The alignment maps points, pixels, voxels or the like from one modality to the points, pixels, voxels or the like from another modality. Factors may also include thermal or electrical changes with respect to the sensors that changes their accuracy or calibrated alignment. As such, reliance on calibrated alignment of sensors is not an accurate means for fusing sensor data.

The camera features projected into the point cloud may be fed into the framework, as described in more detail herein, for flexible fusion. The framework employs an attention-based fusion module that learns to optimally combine camera and radio detection and ranging equipment representations in a context-aware manner. The framework further utilizes a coarse-to-fine training paradigm where coarse predictions are dynamically sampled based on camera and/or radio detection and ranging equipment detections and their neighbors to introduce varying contexts. Accordingly, the framework allows for multiple inference strategies by sampling coarse detections using different policies trained alongside the fusion model for ensemble predictions.

### Environments, Sensor Data, and Vehicles for Coarse-to-Fine Sensor Fusion

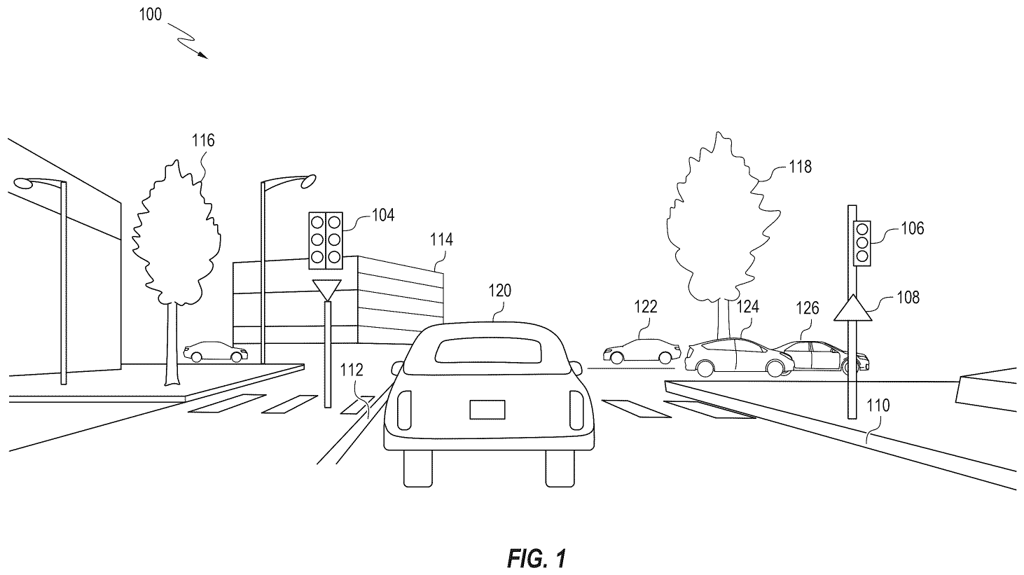

FIG. 1 depicts an illustrative frame of image data 100 of an example environment, such as a city street, generated from a plurality of images captured by one or more image sensors, for example, deployed on a vehicle 120. For example, the vehicle 120 may include one or more cameras configured to capture image data (e.g., video or still images) of the environment. The captured image data may be from bird's eye cameras, panoramic cameras, or other types of cameras deployed on a vehicle 120 to observe the environment around the vehicle 120. The illustrative frame of image data 100 captures features such as signals 104 and 106, signs 108, lane lines 112, buildings 114, curbs and barriers 110 vegetation 116 and 118 street level markings (e.g., crosswalks, turn arrows, and the like) and/or vehicles 122, 124, and 126.

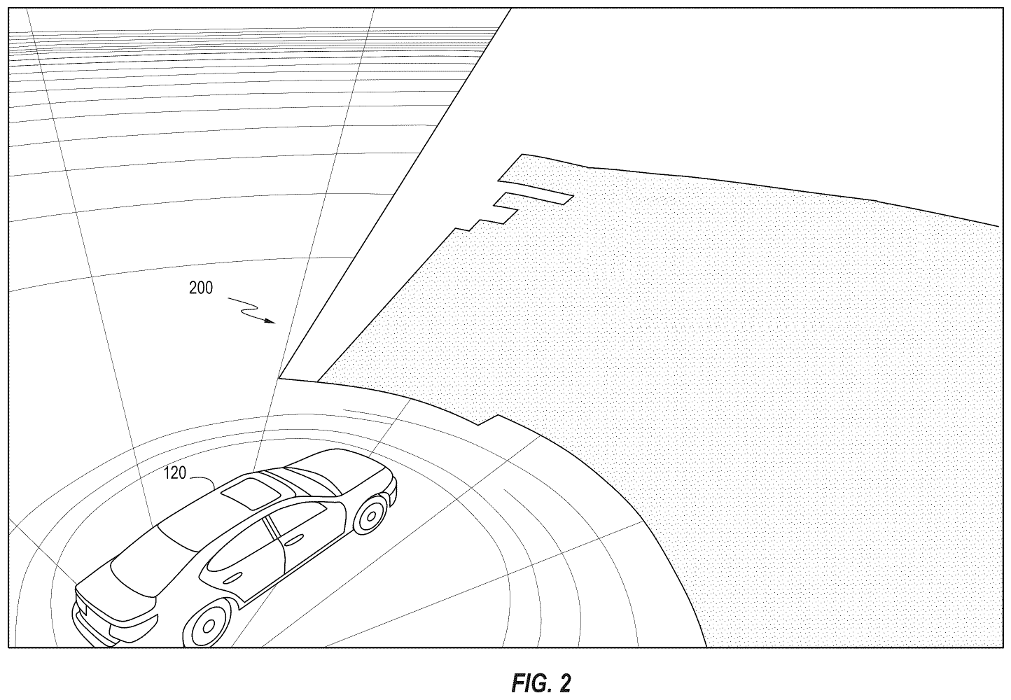

FIG. 2 depicts a point cloud 200 of the example environment, such as a city street, generated by one or more of the sensors equipped on the vehicle 120. Light detection and ranging equipments, radio detection and ranging equipments, SONARs or similar sensor systems may collect the point cloud 200. FIGS. 1 and 2 provide only two example illustrations of data that may be collected by the vehicle 120. Other sensor data collected by the vehicle 120 may include GPS data, inertial measurement unit (IMU) data, depth data, and the like.

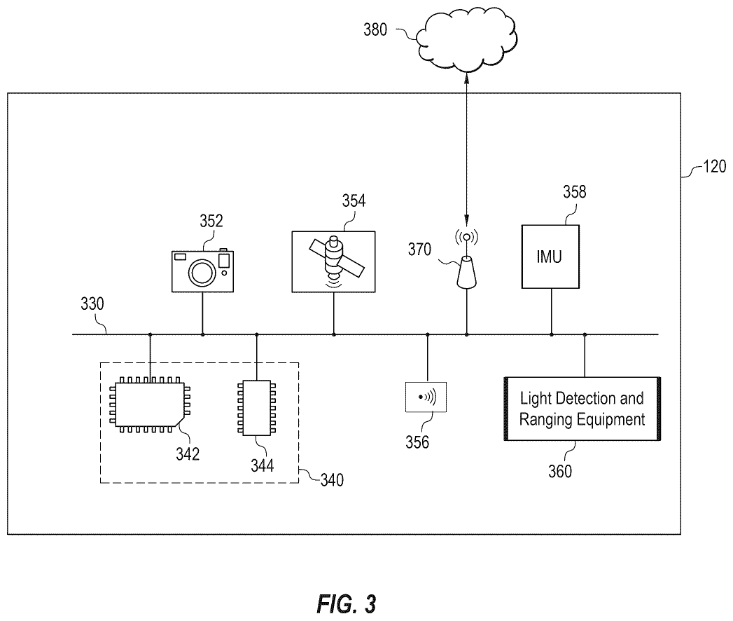

FIG. 3 depicts an illustrative sensor and computing system equipped, for example, in a vehicle 120 or other apparatus, such as a robot. The vehicle 120 depicted in FIG. 3 is depicted by way of an example schematic of a vehicle including sensor resources and a computing device. Not every vehicle is required to be equipped with the same set of sensor resources, nor is every vehicle required to be configured with the same set of systems for perceiving attributes of an environment. FIG. 3 only provides one example configuration of sensor resources and systems equipped within a vehicle. It is understood that aspects described herein are made with reference to implementation with, on, or in a vehicle. However, this is merely an example. The vehicle may be any other apparatus.

In particular, FIG. 3 provides an example schematic of the vehicle 120 including a variety of sensor resources, which may be utilized, by the vehicle 120 to perceive and collect sensor data about the environment. For example, the vehicle 120 may include a computing device 340 comprising one or more processors 342 and a non-transitory computer readable memory 344 (also referred to herein as one or more memories), one or more cameras 352, a global positioning system (GPS) 354, a radio detection and ranging equipment system 356, an IMU 358, a light detection and ranging equipment system 360, and network interface hardware 370. The vehicle 120 may not include all of the components depicted in FIG. 3. In certain aspects, the vehicle 120 may include one or more of the component, such as the one or more cameras 352, the GPS 354, the radio detection and ranging equipment system 356, the IMU 358, the light detection and ranging equipment system 360, a SONAR system, and/or the like. These and other components of the vehicle may be communicatively connected to each other via a communication path 330.

The communication path 330 may be formed from any medium that is capable of transmitting a signal such as, for example, conductive wires, conductive traces, optical waveguides, or the like. The communication path 330 may also refer to the expanse in which electromagnetic radiation and their corresponding electromagnetic waves traverses. Moreover, the communication path 330 may be formed from a combination of mediums capable of transmitting signals. In one embodiment, the communication path 330 comprises a combination of conductive traces, conductive wires, connectors, and buses that cooperate to permit the transmission of electrical data signals to components such as processors, memories, sensors, input devices, output devices, and communication devices. Accordingly, the communication path 330 may comprise a bus. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The computing device 340 may be any device or combination of components comprising one or more processors 342 and non-transitory computer readable memory, referred to herein as one or more memories 344. The one or more processors 342 may be any device(s) capable of executing the processor-executable instructions stored in the one or more memories 344. For example, each of the one or more processors 342 may be an electric controller, an integrated circuit, a microchip, a computer, or any other computing device. The one or more processors 342 are communicatively coupled to the other components of the vehicle 120 by the communication path 330. Accordingly, the communication path 330 may communicatively couple any number of processors 342 with one another, and allow the components coupled to the communication path 330 to operate in a distributed computing environment. Specifically, each of the components may operate as a node that may send and/or receive data.

The one or more memories 344 may comprise RAM, ROM, flash memories, hard drives, or any non-transitory memory device capable of storing processor-executable instructions such that the processor-executable instructions can be accessed and executed by the one or more processors 342. The machine-readable instruction set may comprise logic or algorithm(s) written in any programming language of any generation (e.g., 1GL, 2GL, 3GL, 4GL, or 5GL) such as, for example, machine language that may be directly executed by the one or more processors 342, or assembly language, object-oriented programming (OOP), scripting languages, microcode, etc., that may be compiled or assembled into processor-executable instructions and stored in the one or more memories 344. Alternatively, the processor-executable instructions may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The vehicle 120 may further include one or more cameras 352. The one or more cameras 352 may be any device having an array of sensing devices (e.g., a CCD array or active pixel sensors) capable of detecting radiation in an ultraviolet wavelength band, a visible light wavelength band, or an infrared wavelength band. The one or more cameras 352 may have any resolution. The one or more cameras 352 may be an omni-direction camera or a panoramic camera. In some embodiments, one or more optical components, such as a mirror, fish-eye lens, or any other type of lens may be optically coupled to the one or more cameras 352. The image data collected by the one or more cameras 352 may be stored in the one or more memories 344.

Still referring to FIG. 3, a global positioning system, GPS 354, may be coupled to the communication path 330 and communicatively coupled to the computing device 340 of the vehicle 120. The GPS 354 is capable of generating location information indicative of a location of the vehicle 120 by receiving one or more GPS signals from one or more GPS satellites. The GPS signal communicated to the computing device 340 via the communication path 330 may include location information comprising a National Marine Electronics Association (NMEA) message, a latitude and longitude data set, a street address, a name of a known location based on a location database, or the like. Additionally, the GPS 354 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The sensor data collected by the GPS 354 may be stored in the one or more memories 344.

The vehicle 120 may also include a radio detection and ranging equipment system 356. The radio detection and ranging equipment system 356 measures the distance to objects over wide distances. It is also possible to measure the relative speed of the detected object. The radio detection and ranging equipment system 356 may be a continuous wave (CW), frequency-modulated continuous wave (FMCW), 3D-radio detection and ranging equipment (3D FMCW multiple-input and multiple-output (MIMO)), or 4D-radio detection and ranging equipment (4D FMCW MIMO). The sensor data collected by the radio detection and ranging equipment system 356 may be stored in the one or more memories 344.

The vehicle 120 may include an inertial measurement unit (IMU) 358. The IMU 358 is an electronic device that measures and reports a vehicle's specific force, angular rate, and sometimes the orientation of the vehicle, using a combination of accelerometers, gyroscopes, and sometimes magnetometers. The sensor data collected by the IMU 358 may be stored in the one or more memories 344.

In some aspects, the vehicle 120 may include a light detection and ranging equipment system 360. The light detection and ranging equipment system 360 is communicatively coupled to the communication path 330 and the computing device 340. A light detection and ranging equipment system 360 or light detection and ranging is a system and method of using pulsed laser light to measure distances from the light detection and ranging equipment system 360 to objects that reflect the pulsed laser light. A light detection and ranging equipment system 360 may be made as solid-state devices with few or no moving parts, including those configured as optical phased array devices where its prism-like operation permits a wide field-of-view without the weight and size complexities associated with a traditional rotating light detection and ranging equipment system 360. The light detection and ranging equipment system 360 is particularly suited to measuring time-of-flight, which in turn can be correlated to distance measurements with objects that are within a field-of-view of the light detection and ranging equipment system 360. By calculating the difference in return time of the various wavelengths of the pulsed laser light emitted by the light detection and ranging equipment system 360, a digital 3-D representation of a target or environment may be generated. The pulsed laser light emitted by the light detection and ranging equipment system 360 include emissions operated in or near the infrared range of the electromagnetic spectrum, for example, having emitted radiation of about 905 nanometers. Sensors such as the light detection and ranging equipment system 360 can be used by vehicles to provide detailed 3D spatial information for the identification of objects near the vehicle 120, as well as the use of such information in the service of systems for vehicular mapping, navigation and autonomous operations, especially when used in conjunction with geo-referencing devices such as GPS 354 or a gyroscope-based inertial navigation unit (INU, not shown or IMU 358) or related dead-reckoning system. The point cloud data collected by the light detection and ranging equipment system 360 may be stored in the one or more memories 344.

Still referring to FIG. 3, vehicles are now more commonly equipped with vehicle-to-vehicle communication systems. Some of the systems rely on network interface hardware 370. The network interface hardware 370 may be coupled to the communication path 330 and communicatively coupled to the computing device 340. The network interface hardware 370 may be any device capable of transmitting and/or receiving data with a network 380 or directly with another vehicle equipped with a vehicle-to-vehicle communication system. Accordingly, network interface hardware 370 can include a communication transceiver for sending and/or receiving any wired or wireless communication. For example, the network interface hardware 370 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 370 includes hardware configured to operate in accordance with the Bluetooth wireless communication protocol. In another embodiment, network interface hardware 370 may include a Bluetooth send/receive module for sending and receiving Bluetooth communications to/from a network 380 and/or another vehicle.

### Framework for Coarse-to-Fine Attention-Based Multiple Sensor Fusion

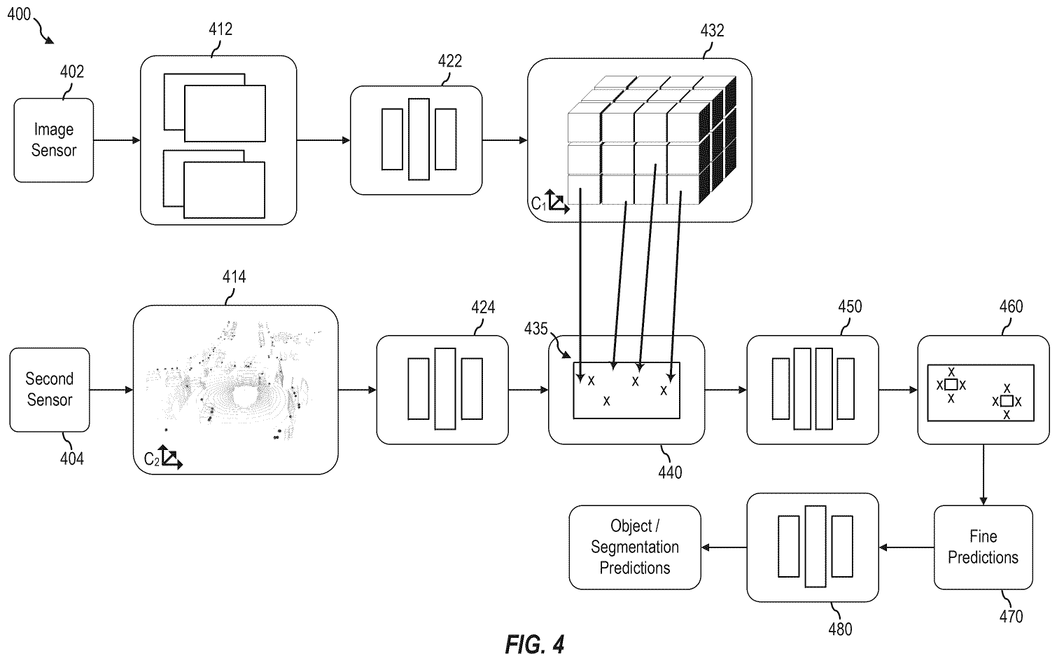

FIG. 4 depicts an illustrative framework 400 of a coarse-to-fine fusion network. The framework 400 will be described in the context of implementation by a computing device and sensors deployed on a vehicle, however, this is only one example implementation. The framework 400 may be implemented in any suitable computing device.

As discussed with reference to FIGS. 1-3, sensor data may be collected by a vehicle 120 traversing an environment. The sensor data comprises information such as point cloud 414, image data 412, IMU data, GPS data, and/or the like. In certain aspects, one or more sensors, such as having different perception modalities, collect the sensor data. For example, one or more image sensors 402 may be implemented to capture a plurality of images, collectively referred to as image data 412. Additionally, one or more second sensors 404, such as radio detection and ranging equipment, light detection and ranging equipment, SONAR, or the like, may be implemented to capture a point cloud 414 of an environment. The sensors may each have a corresponding coordinate system, for example, C₁ and C₂. The respective coordinate systems may be calibrated such that the information collected in each may at least be generally aligned. Since calibration changes over time as a result of external factors, the calibration alone may not be able to be used to generate fine fusion between the data from each sensor. Accordingly, in certain aspects, the coarse-to-fine sensor fusion processes described herein may not need perfect calibration between the sensors.

In certain aspects, the image data 412 includes a plurality of images, where each image may have a slightly different point of view of the environment. The plurality of images may be stitched together to form a surround view, also referred to as a bird's eye view of the environment. There are various known processes for generating a surround view image of an environment from a plurality of images, for example, such as Birds Eye View (BEV) by RidgeRun.

Features in the image data 412 are identified at block 422. Block 422 may implement a first machine learning model which may be one or more various feature extraction, segmentation, or classification networks to identify features present in the image data 412. For example, features may include distinctive or salient points, corners, edges, shapes, and/or blobs. The features information (e.g., an example of first features) may be labeled in the image data 412 so that the information can be shared or imparted on points in the point cloud 414 as discussed herein.

In some aspects the image data 412 includes two-dimensional image data. Through stitching processes or similar surround view generation processes, the labeled image data 412 is expressed in a 3D voxel image space 432. A 3D voxel image space may be a 3D representation of pixels and corresponding information from image data 412 mapped into a 3D coordinate system. The 3D voxel image space may not correspond to a defined coordinate system, but instead the position of voxels may be based upon positions relative to other voxels thereby forming a volumetric image. The image data 412 may be labeled at the pixel level. That is, each pixel may include feature information in addition to color information, location information, and the like. When the pixels are expressed in the 3D voxel image space, one or more pixels may be combined to define a voxel within the 3D voxel image space. The 3D voxel image space 432 may adopt a coordinate system C₁ that is derived from a combination of the coordinate systems from each of the individual images of the plurality of images making up the image data 412. For example, a VoxelSpace engine developed by NovaLogic® may be used to render the 3D voxel image space 432 from the plurality of images. The coordinate system C₁ provides an initial reference for projecting voxels (e.g., each having feature information) into the point cloud.

As discussed above, one or more second sensors 404, such as radio detection and ranging equipment, light detection and ranging equipment, sonar, or the like may be employed to capture a point cloud 414 of the environment. The point cloud 414 may not include as dense of information as the image data 412, but the one or more second sensors used to generate the point cloud 414 may be capable of perceiving information that the one or more image sensors 402 may be unable to perceive. Although the point cloud 414 may be sparse, features can also be extracted and/or labeled.

At block 424, the point cloud 414 may be processed using a second machine learning model which may be a point cloud feature extraction, classification, or segmentation model, such as PointNet or VoxelNet to identify features and label points in the point cloud as corresponding to identified features. As such, the points in the point cloud 414 may include feature information (e.g., an example of second features).

A coarse representation 435 of the environment may be generated by projecting the first features onto the points in the point cloud at block 440. The projection is based on combining a respective set of the first features within a first radius from a point with a respective set of the second features corresponding to the point, for each of a first plurality of points in the point cloud. For example, for each point, rⱼ, in the point cloud, nearby camera points, pᵢ, (e.g., also referred to as voxels from the 3D voxel image space of the environment) are determined based on a radius, d, from the point.

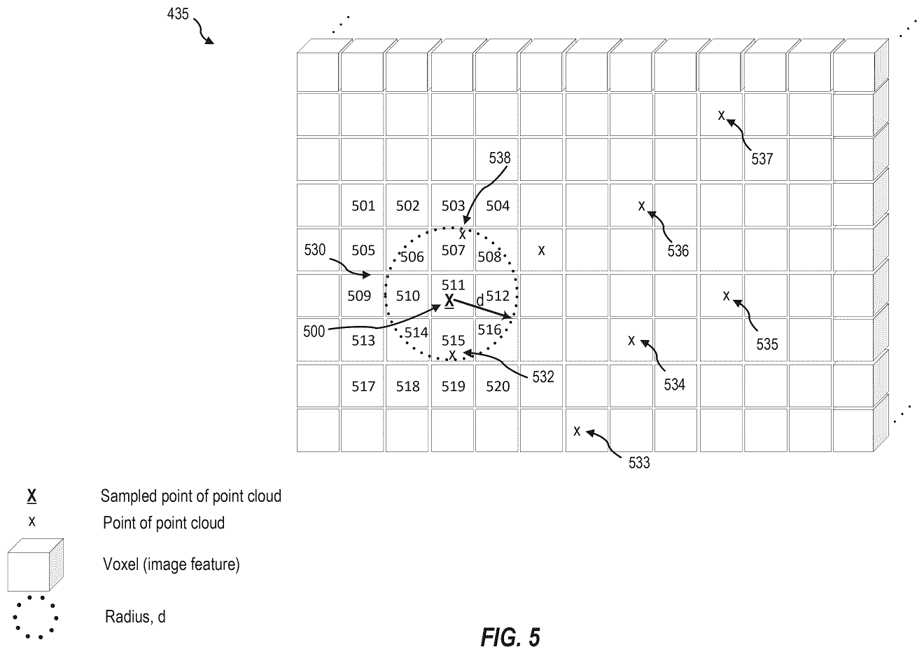

FIG. 5 depicts an illustrative projection of the first features from voxels in the 3D voxel image space into the point cloud. For example, point 500 is shown as an example point r₅₀₀ in the point cloud space. The squares depicted in FIG. 5 correspond to voxels in the 3D voxel image space. Although the radius, d, from the point r₅₀₀ is generally a 2D representation, it should be understood that the radius, d, may extend in three dimensions around the point r₅₀₀. Each camera point, pᵢ, within the radius, d, from the point r₅₀₀ forms a set of nearby camera points, Nj. The set of nearby camera points, Nj may be expressed by the following function: Nⱼ={pᵢ∥pᵢ−rⱼ|<d}. As depicted in the illustrative projection in FIG. 5, the nearby camera points include at least points 506, 507, 508, 510, 511, 512, 514, 515, and 516. Projection of the nearby camera points into the point cloud frame can be accomplished following the process. For each pᵢ in Nⱼ: rᵢi=R*pᵢ−t, where R is the extrinsic rotation matrix from camera to radio detection and ranging equipment frame and t is the extrinsic translation vector. For each projected point rᵢ, there is an extracted camera feature vector, f_{{i,c}}. The camera features may be aggregated. Aggregation of the camera feature vectors is weighted based on an aggregation weight, wᵢ. For example, the aggregated camera feature vector, f_{{r}_{ⱼ}_{}}, is defined by f_{{r}_{ⱼ}_{}}=Σᵢwᵢ*f_{{i,c}}, where rⱼ is the point in the point cloud. Moreover, f_{{i,c}} is the individual camera feature vector for the i^{{th}} projected camera point. The summation aggregates the weighted camera features over all projected points within the neighborhood of rⱼ, for example, point r₅₀₀ shown in FIG. 5. The aggregation weights, wᵢ may be learned values.

In an similar manner, other points and the corresponding second features of the other points that are within the radius, d, of the currently sampled point (e.g., point r₅₀₀) may be grouped following: Rⱼ={rₖ: ∥rₖ−rᵢ∥<d, ∀rᵢ∈Nⱼ}. Rj is the set of points grouped with rⱼ. As depicted in FIG. 5, Rj would include points 532 and 538. Points 533, 534, 535, 536, and 537 are not within the radius, d, of the currently sampled point. rₖ represents each individual point, for example, points 532 and 538. rᵢ represents the projected camera points from Nⱼ. As previously defined, Nⱼ is the set of nearby camera points to rⱼ. Thus, |rₖ−rᵢ| is taking the absolute value of the distance between each original return rₖ (e.g., radio detection and ranging equipment return) and the projected camera points rᵢ and “<d” means within a distance d (e.g., radius, d). Finally, ∀rᵢ∈Nⱼ indicates this must be true for all projected points rᵢ that are members of the set Nⱼ. Accordingly, Rⱼ contains all original returns rₖ whose distance to any of the projected camera points rᵢ is less than the threshold d. This groups the sparse second sensor data, such as sparse radio detection and ranging equipment data, with the dense features from the one or more image sensors 402.

Still referring to block 440 of FIG. 4 and the illustrative projection depicted in FIG. 5 the second features corresponding to the points in the point cloud may be aggregated following:

$${f}_{\{ {r}_{k} \}} = \frac{1}{N} {\sum }_{{r}_{k}} {f}_{\{ {r}_{k} \}} ,$$

where f_{{r}_{ₖ}_{}} is the aggregated radio detection and ranging equipment feature vector for the group. N is the total number of radio detection and ranging equipment returns in the group. For example, N is 3 for illustrative projection depicted in FIG. 5. The summation is divided by N to get the average of the radio detection and ranging equipment features. This equation computes the aggregated radio detection and ranging equipment feature vector for each group Rⱼ by taking the mean of the individual radio detection and ranging equipment return features.

The coarse representation 435 is a combination of the first features from the image data and the second features from the point cloud data. Following the aforementioned illustrative projection processes, the first features from the image data and the second features from the point cloud data form a combined representation, f′{rⱼ}=[f_{{r}_{ⱼ}_{}}, f_{{r}_{ₖ}_{}}], f_{{r}_{ⱼ}_{}} is the aggregated camera feature vector and f_{{r}_{ₖ}_{}} is the aggregated radio detection and ranging equipment feature vector for the group. It should be understood that although radio detection and ranging equipment and radio detection and ranging equipment features are discussed with reference to describing the projection processes herein, other types of second sensors, such as light detection and ranging equipment, SONAR, or the like may be used in place of radio detection and ranging equipment or in combination with radio detection and ranging equipment.

After projecting first features from the image data to the point cloud and combining the features as previously described, coarse pass training techniques are performed to determine key locations. Key locations refer to points or positions within the coarse representation 435 (e.g., the sensor grid that is formed from the projection of the first features from the image data to the point cloud). The key locations are crucial or significant locations for guiding the deformable attention module during the inference or deployment phase of the perception system implementing aspects described herein. These key locations are identified through a coarse pass technique, which includes sampling points from the radio detection and ranging equipment grid (e.g., the point cloud) or other sensor data in a strategic manner. For example, the locations may be selected based on various criteria, such as the location's relevance to the task at hand, the location's potential to provide valuable information, and/or the location's ability to guide the attention mechanism. For example, if the task is navigation, then locations corresponding to features such as road features and structures may be strategically sampled. If the task is collision avoidance, locations corresponding to features such as objects, persons, animals, or the like may be strategically sampled.

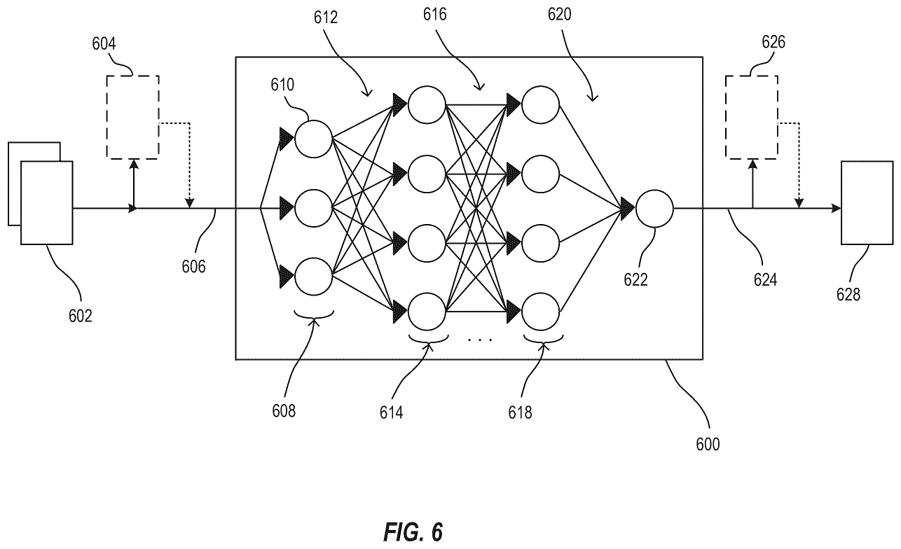

The coarse pass generally includes uniformly sampling points (e.g., locations) corresponding to the point cloud in the coarse representation 435. These locations are then used to extract features and guide the subsequent fine pass refinement process. The selection of the key locations may help to ensure that the attention mechanism focuses on important areas within the sensor data, which in turn may contribute to more accurate and informed predictions. The extracted features corresponding to the sampled points are forwarded to the fusion module 450 to determine a loss on the sampled points. For example, each grid point, P={p₁, p₂, . . . pᵢ} in the coarse representation 435 includes projected first features (e.g., camera features f_{{i,c}}) and second features (e.g., radio detection and ranging equipment features f_{{i,r}}). A number, N, of the grid points, P, are selected at random, for example, generating P_{coarse}={pr₁, pr₂, . . . , prᵢ, pr_{N}). The first features f_{{pr}_{ᵢ}_{,c}} and second features f_{{pr}_{ᵢ}_{,r}} corresponding to the selected grid points, P_{coarse} (prᵢ), are extracted and forwarded to the fusion module 450. The fusion module 450, which may be an ANN (e.g., an ANN 600 depicted in FIG. 6). The fusion module 450 combines information from multiple sensor modalities, such as cameras and radio detection and ranging equipments, to create a unified representation that captures the features observed by each modality. In certain aspects, the fusion module 450 combines features extracted from both camera and radio detection and ranging equipment data to create a fused representation that integrates complementary information from both sources. The fusion process involves aggregating and weighting the features from each modality, followed by concatenation or other operations to combine them into a single feature vector. This fused representation is then passed to subsequent layers for further processing and prediction.

The fusion module 450 may be an ANN or other type of machine learning model having an encoder-decoder architecture. The encoder-decoder architecture may be a framework that is commonly used in various machine learning tasks, for example, but not limited to perception tasks like object detection or semantic segmentation.

The encoder receives input data, for example, the fused representation from the fusion module 450 and processes it into a condensed, higher-level representation that captures important features of the input. More particularly, the encoder receives the first features f_{{pr}_{ᵢ}_{,c}} and second features f_{{pr}_{ᵢ}_{,r}} corresponding to the selected grid points, P_{coarse} (prᵢ), and generates concatenated feature embedding, hᵢ.

The decoder then takes this condensed representation and reconstructs or decodes it into an output format suitable for the task at hand, such as object labels or environmental semantics. The decoder provides an estimate ŷᵢ for computing the loss (e.g., a Cross-Entropy loss function, CE (yᵢ, ŷᵢ)) corresponding to the features of the selected grid points. Here, yᵢ represents the ground truth or target labels for the data points being processed. The estimate ŷᵢ represents the predicted or estimated output corresponding to a specific data point or grid point i. These operations may be implemented using neural networks, with the encoder network extracting features through convolutional layers and the decoder network reconstructing the output through upsampling or deconvolutional layers.

The prediction generated by the decoder component of the fusion module 450 (e.g., a neural network) is based on the input features and the learned parameters of the model. CE(yᵢ, ŷᵢ) is an example loss function which measures the difference between the predicted probability distribution (ŷᵢ) and the true distribution (yᵢ) of class labels. The loss function penalizes deviations between the predicted and true distributions, thereby encouraging the model to produce predictions that closely match the ground truth labels. Accordingly, by optimizing the Cross-Entropy loss during training, the model learns to make accurate predictions that align with the desired output.

The coarse representation 435 provides initial predictions regarding the fusion of the first features and second features. The fine pass 460 refines the predictions using features from both modalities fused together. This helps reinforce and combine the learned representations. The network learns optimal fusion weights (e.g., the aggregation weights, wᵢ) to combine camera features (e.g., the first features) and radio detection and ranging equipment features (e.g., the second features) through the losses generated during the iterative training process.

The aggregation weights, wᵢ, may be initially assigned random values. During training of the fusion module 450, for example, during the forward pass, the fusion module 450 receives as input the features extracted from both camera and radio detection and ranging equipment data. These features are combined using the aggregation weights, wᵢ, to create a fused representation. The fused representation may then be passed through the encoder-decoder structure to make predictions about the environment and/or objects of interest. As discussed herein, the predictions made by the model (e.g., the neural network of the fusion module 450) are compared to the ground truth labels using a loss function, such as Cross-Entropy loss. The loss may be backpropagated through the network, and gradients can be computed with respect to all the parameters, including the aggregation weights, wᵢ.

An optimizer may update the aggregation weights, wᵢ, as well as other parameters of the fusion module 450 in the direction that minimizes the loss. This process continues iteratively over multiple training epochs. During the optimization process, the aggregation weights can be adjusted to minimize the discrepancy between the predictions and the ground truth labels. The weights may be updated based on how they contribute to reducing the overall loss, rather than being directly influenced by the loss values themselves. Accordingly, while the computed loss indirectly guides the optimization of the aggregation weights, wᵢ, through backpropagation, the weights themselves are not explicitly adjusted based on the loss values. Instead, they are updated as part of the overall parameter optimization process to improve the model's performance in predicting the desired outcomes.

The process of sampling points sparsely, optionally includes varying the radius, d, during the coarse pass and then densely sampling points during the fine pass, helps the radio detection and ranging equipment leverage context from the camera's wider field of view in a memory-efficient way. In other words, generating a coarse representation and fusion of the first features and the second features at a coarse level, for example, guided by select points of the point cloud does not require the amount of memory or computational resources compared to a direct dense sampling process not guided by specific points in the point cloud. The coarse predictions serve as an initialization, making the fine tuning process more stable and less likely to diverge compared to training from scratch. Both modalities are processed through the same encoder-attention-decoder structure, encouraging their internal representations to be aligned. Accordingly, aspects provide an effective framework for the network to learn from both camera and radio detection and ranging equipment through iterative coarse-fine training with modality feature sharing fusion and end-to-end optimization that helps each modality impart knowledge to the other.

The following discusses the generation of the fine representation 470 from the fine pass 460 in more detail. The location of points, P={p₁, p₂, . . . pᵢ} in the coarse representation are encoded using positional encodings: pᵢ′=PositionalEncoding (pᵢ). Positional encodings describe the location or position of an entity (e.g., a point) in a sequence so that each position is assigned a unique representation. The fine pass 460 extracts coarse features, f_{p′}, from the image data. A deformable attention module is applied to the coarse representation and guided by the positional encodings to predict fine sampling locations: Q=f_{p′}. Accordingly, initiation of the deformable attention module can be expressed with the following notation DeformableAttention (Q, P). The deformable attention module densely samples predicted fine points: N (pᵢ)={q1, q2, . . . , qm} corresponding to the coarse point locations P={p₁, p₂, . . . pᵢ} encoded as the positional encodings pᵢ′. Fine features fq are then extracted from the image data at the predicted fine points N (pᵢ)={q1, q2, . . . , qm}. Fine features refer to features that correspond to, for example, labels, to the fine points. An attention mechanism, such as an attention model or attention component of the deformable attention module, fuses the coarse and fine features to generate the fine representation, Fpᵢ=Attention (fp′, {fq|q∈N (pᵢ)}). The fine representation may be a fusion of the fine features and the coarse representation such that a dense representation of the environment is formed from features of each sensor modality.

The attention mechanism may include computing a softmax of the feature vector,

$${f}_{p}^{′} ,$$

representing the i^{{th}} coarse point

$${p}_{i}^{′} ;$$

the feature vector, f_{{q,j}}, of the j^{{th}} predicted fine point qⱼ in the neighborhood N(pᵢ), and a learned linear projection matrix, W. For example, the attention mechanism can be expressed by the following equation:

$${α}_{\{ i , j \}} = Softmax ( {f}_{p}^{′} {Wf}_{\{ q , j \}} ) .$$

The softmax may be taken over all predicted fine points, qⱼ ∈N (pᵢ), to compute the attention weights, α_{{i,j}} between the coarse point and each fine point. That is, the attention weights, α_{{i,j}}, may be computed by measuring the compatibility of the coarse point feature,

$${f}_{p}^{′} ,$$

with each fine point feature, f_{{q,j}}.

The fine pass 460 continues with generating an attended feature F_{{p}_{ᵢ}_{}}. The attended feature F_{{p}_{ᵢ}_{}} is computed as a weighted sum of the fine point features f_{{q,j}}, where the weights are the attention weights α_{{i,j}}. The computation follows equation: F_{{p}_{ᵢ}_{}}=Σⱼα_{{i,j}} f_{{q,j}}. This sums the fine point features according to their attention weights to produce the attended context-aware feature F_{{p}_{ᵢ}_{}} for the coarse point pᵢ. Accordingly, the attended coarse point feature is computed by aggregating the fine point features weighted by their learned attention weights.

The fine representation 470 is the resulting fusion of the features from the image data (e.g., the first features) and the features from the point cloud (e.g., the second features), where the correspondences between the voxels in the 3D voxel image space and the points in the point cloud are aligned through coarse-to-fine sensor fusion processes described herein. It should be understood that the coarse-to-fine sensor fusion processes described herein leverage deformable attention to dynamically predict fine sampling locations based on coarse features, without relying on fixed neighborhoods. The learned attention then enables fusing of features at multiple scales.

In certain embodiments, the attended context-aware feature F_{{p}_{ᵢ}_{}} can be used to perform one or more object detection operations or one or more segmentation operations at block 480. These operations may utilize one or more ANNs such as ANN 600 depicted in FIG. 6. An example of an ANN may be a 3D ConvNet or the like.

### Example Neural Network Architecture for Neural Representation

FIG. 6 is an illustrative block diagram of an example artificial neural network (ANN) 600.

The ANN 600 may receive input data 606 which may include one or more bits of data 602, pre-processed data output from the pre-processor 604 (optional), or some combination thereof. Here, the data 602, such as sensor data may include training data, verification data, application-related data, or the like, e.g., depending on the stage of development and/or deployment of the ANN 600. A pre-processor 604 may be included within the ANN 600 in some other implementations. The pre-processor 604 may, for example, process all or a portion of data 602, which may result in some of data 602 being changed, replaced, deleted, etc. In some implementations, the pre-processor 604 may add additional data to the data 602.

The ANN 600 includes at least one first layer 608 of artificial neurons 610 to process input data 606 and provide a resulting first layer output data via the edges 612 to at least a portion of at least one second layer 614. The second layer 614 processes data received via the edges 612 and provides a second layer output data via the edges 616 to at least a portion of at least one third layer 618. The third layer 618 processes data received via the edges 616 and provides the third layer output data via the edges 620 to at least a portion of a final layer 622 including one or more neurons to provide output data 624. All or part of the output data 624 may be further processed in some manner by (optional) post-processor 626. Thus, in certain examples, the ANN 600 may provide the output data 628 that is based on the output data 624, post-processed data output from the post-processor 626, or some combination thereof. The post-processor 626 may be included within the ANN 600 in some other implementations. The post-processor 626 may, for example, process all or a portion of the output data 624 which may result in the output data 628 being different, at least in part, to the output data 624, e.g., as result of data being changed, replaced, deleted, etc. In some implementations, the post-processor 626 may be configured to add additional data to the output data 624. In this example, the second layer 614 and the third layer 618 represent intermediate or hidden layers that may be arranged in a hierarchical or other like structure. Although not explicitly shown, there may be one or more further intermediate layers between the second layer 614 and the third layer 618.

The structure and training of artificial neurons 610 in the various layers may be tailored to specific requirements of an application. Within a given layer of an ANN 600, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data 606. Some non-exhaustive example activation functions include a linear function, binary step function, sigmoid, tanh, ReLU and variants, exponential linear unit (ELU), Swish, Softmax, and others.

Design tools (such as computer applications, programs, etc.) may be used to select appropriate structures for the ANN 600 and a number of layers and a number of artificial neurons in each layer, as well as selecting activation functions, a loss function, training processes, etc. Once an initial model has been designed, training of the model may be conducted using training data. Training data may include one or more datasets within which the ANN 600 may detect, determine, identify or ascertain patterns. Training data may represent various types of information, including written, visual, audio, environmental context, operational properties, etc. During training, parameters of the artificial neurons 610 may be changed, such as to minimize or otherwise reduce a loss function or a cost function. A training process may be repeated multiple times to fine-tune the ANN 600 with each iteration.

The ANN 600 or other ML models may be implemented in various types of processing circuits along with memory and applicable instructions therein. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

There are a variety of model training techniques and processes that may be used prior to, or at some point following, deployment of an ML model.

As part of a model development process, information in the form of applicable training data may be gathered or otherwise created for use in training an ML model accordingly. Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as neural network 520 of FIG. 5, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

### Example Operations

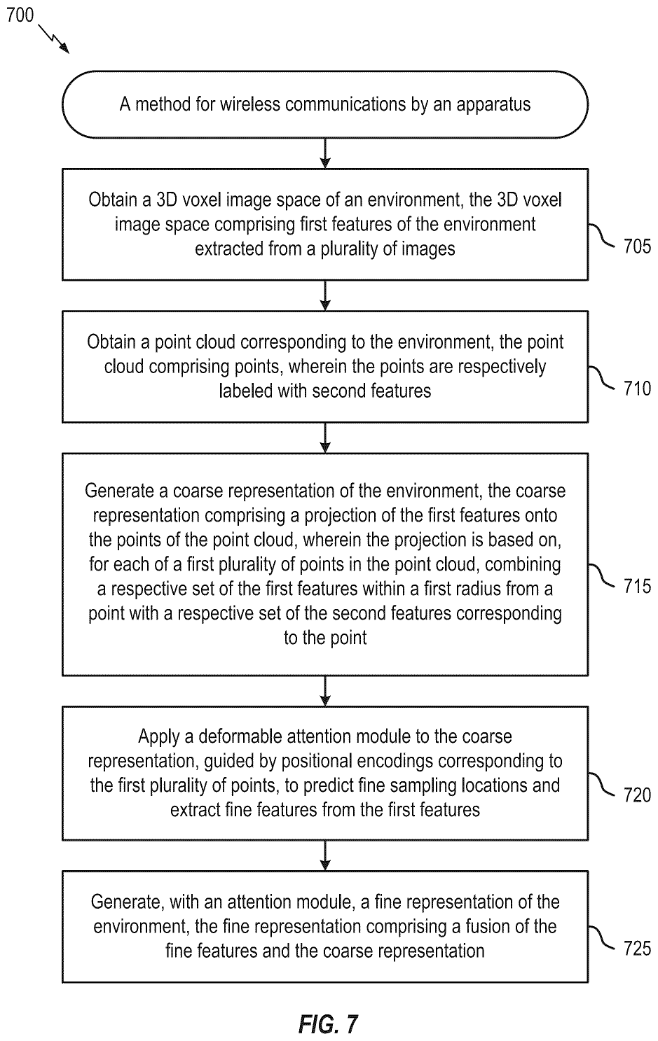

FIG. 7 shows a method 700 for coarse-to-fine attention-based multiple sensor fusion by an apparatus, such a computing device 340 and/or vehicle 120 of FIGS. 1 and 3.

Method 700 begins at block 705 with obtaining a 3D voxel image space of an environment, the 3D voxel image space comprising first features of the environment extracted from a plurality of images.

Method 700 then proceeds to block 710 with obtaining a point cloud corresponding to the environment, the point cloud comprising points, wherein the points are respectively labeled with second features.

Method 700 then proceeds to block 715 with generating a coarse representation of the environment, the coarse representation comprising a projection of the first features onto the points of the point cloud, wherein the projection is based on, for each of a first plurality of points in the point cloud, combining a respective set of the first features within a first radius from a point with a respective set of the second features corresponding to the point.

Method 700 then proceeds to block 720 with applying a deformable attention module to the coarse representation, guided by positional encodings corresponding to the first plurality of points, to predict fine sampling locations and extract fine features from the first features.

Method 700 then proceeds to block 725 with generating, with an attention module, a fine representation of the environment, the fine representation comprising a fusion of the fine features and the coarse representation.

In certain aspects, block 715 includes: aligning a first coordinate system of the 3D voxel image space with a second coordinate system of the point cloud; determining, for each of the first plurality of points in the point cloud, respective voxels from the 3D voxel image space within the first radius of the respective point according to the aligned first and second coordinate systems; projecting, for each of the first plurality of points, the respective set of the first features corresponding to the respective voxels to the point; aggregating, for each of the first plurality of points, the respective set of the first features to form a respective aggregated first feature vector corresponding to the point; aggregating, for each of the first plurality of points, sets of the second features corresponding to other points of the point cloud within the first radius of the point with the second features corresponding to the point to form a respective aggregated second feature vector corresponding to the point; and combining, for each of the first plurality of points, the respective aggregated first feature vector and the respective aggregated second feature vector to form the coarse representation.

In certain aspects, the projection, for each of the first plurality of points, is further based on applying a respective set of aggregation weights to the respective set of the first features and combining the respective set of the first features weighted by the respective set of the aggregation weights with the respective set of the second features.

In certain aspects, each of the respective set of the aggregation weights is learned by iteratively generating coarse representations based on different radius values for the first radius.

In certain aspects, each of the respective set of the aggregation weights is learned by iteratively generating coarse representations based on different points forming the first plurality of points.

In certain aspects, method 700 further includes obtaining, with a first machine learning model, the first features from the plurality of images.

In certain aspects, method 700 further includes mapping the first features obtained from the plurality of images into the 3D voxel image space.

In certain aspects, method 700 further includes obtaining, with a second machine learning model, the second features from the point cloud.

In certain aspects, the point cloud of the environment is captured by at least one of a radio detection and ranging equipment or a light detection and ranging equipment.

In certain aspects, the first plurality of points in the point cloud comprises less than a total number of points in the point cloud.

In certain aspects, method 700 further includes performing one or more object detection operations based on the fine representation.

In certain aspects, method 700 further includes performing one or more segmentation operations based on the fine representation.

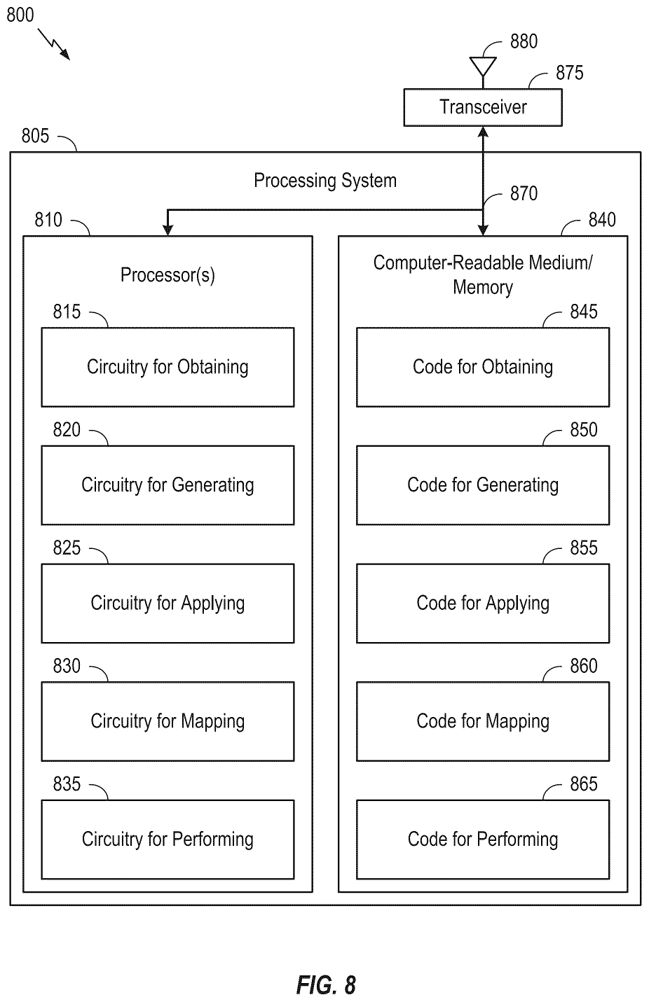

In certain aspects, method 700, or any aspect related to it, may be performed by an apparatus, such as apparatus 800 of FIG. 8, which includes various components operable, configured, or adapted to perform the method 700. Apparatus 800 is described below in further detail.

Note that FIG. 7 is just one example of a method, and other methods including fewer, additional, or alternative operations are possible consistent with this disclosure.

### Example Apparatus

FIG. 8 depicts aspects of an example apparatus 800. In some aspects, apparatus 800 is a computing device 340, for example, but not limited to being implemented by a vehicle 120 described above with respect to FIGS. 1 and 3.

The apparatus 800 includes a processing system 805, which may be coupled to a transceiver 875 (e.g., a transmitter and/or a receiver). The transceiver 875 is configured to transmit and receive signals for the apparatus 800 via an antenna 880, such as the various signals as described herein. The processing system 805 may be configured to perform processing functions for the apparatus 800, including processing signals received and/or to be transmitted by the apparatus 800.

The processing system 805 includes one or more processors 810. Generally, processor(s) 810 may be configured to execute computer-executable instructions (e.g., software code) to perform various functions, as described herein. The one or more processors 810 are coupled to a computer-readable medium/memory 840 via a bus 870. In certain aspects, the computer-readable medium/memory 840 is configured to store instructions (e.g., computer-executable code) that when executed by the one or more processors 810, enable and cause the one or more processors 810 to perform the method 700 described with respect to FIG. 7, or any aspect related to it, including any operations described in relation to FIG. 7. Note that reference to a processor performing a function of the apparatus 800 may include one or more processors performing that function of the apparatus 800, such as in a distributed fashion.

In the depicted example, computer-readable medium/memory 840 stores code for obtaining 845, code for generating 850, code for applying 855, code for mapping 860, and code for performing 865. Processing of the code 845-865 may enable and cause the apparatus 800 to perform the method 700 described with respect to FIG. 7, or any aspect related to it.

The one or more processors 810 include circuitry configured to implement (e.g., execute) the code stored in the computer-readable medium/memory 840, including circuitry for obtaining 815, circuitry for generating 820, circuitry for applying 825, circuitry for mapping 830, and circuitry for performing 835. Processing with circuitry 815-835 may enable and cause the apparatus 800 to perform the method 700 described with respect to FIG. 7, or any aspect related to it.

Apparatus 800 may be implemented in various ways. For example, apparatus 800 may be implemented within on-site, remote, or cloud-based processing equipment.

Apparatus 800 is just one example, and other configurations are possible. For example, in alternative aspects, aspects described with respect to apparatus 800 may be omitted, added, or substituted for alternative aspects.

### Example Clauses

Implementation examples are described in the following numbered clauses:

Clause 1: A method comprising: obtaining a 3D voxel image space of an environment, the 3D voxel image space comprising first features of the environment extracted from a plurality of images; obtaining a point cloud corresponding to the environment, the point cloud comprising points, wherein the points are respectively labeled with second features; generating a coarse representation of the environment, the coarse representation comprising a projection of the first features onto the points of the point cloud, wherein the projection is based on, for each of a first plurality of points in the point cloud, combining a respective set of the first features within a first radius from a point with a respective set of the second features corresponding to the point; applying a deformable attention module to the coarse representation, guided by positional encodings corresponding to the first plurality of points, to predict fine sampling locations and extract fine features from the first features; and generating, with an attention module, a fine representation of the environment, the fine representation comprising a fusion of the fine features and the coarse representation.

Clause 2: The method of Clause 1, wherein generating the coarse representation comprises: aligning a first coordinate system of the 3D voxel image space with a second coordinate system of the point cloud; determining, for each of the first plurality of points in the point cloud, respective voxels from the 3D voxel image space within the first radius of the respective point according to the aligned first and second coordinate systems; projecting, for each of the first plurality of points, the respective set of the first features corresponding to the respective voxels to the point; aggregating, for each of the first plurality of points, the respective set of the first features to form a respective aggregated first feature vector corresponding to the point; aggregating, for each of the first plurality of points, sets of the second features corresponding to other points of the point cloud within the first radius of the point with the second features corresponding to the point to form a respective aggregated second feature vector corresponding to the point; and combining, for each of the first plurality of points, the respective aggregated first feature vector and the respective aggregated second feature vector to form the coarse representation.

Clause 3: The method of any one of Clauses 1-2, wherein the projection, for each of the first plurality of points, is further based on applying a respective set of aggregation weights to the respective set of the first features and combining the respective set of the first features weighted by the respective set of the aggregation weights with the respective set of the second features.

Clause 4: The method of Clause 3, wherein each of the respective set of the aggregation weights is learned by iteratively generating coarse representations based on different radius values for the first radius.

Clause 5: The method of Clause 3, wherein each of the respective set of the aggregation weights is learned by iteratively generating coarse representations based on different points forming the first plurality of points.

Clause 6: The method of any one of Clauses 1-5, further comprising: obtaining, with a first machine learning model, the first features from the plurality of images; and mapping the first features obtained from the plurality of images into the 3D voxel image space.

Clause 7: The method of any one of Clauses 1-6, further comprising obtaining, with a second machine learning model, the second features from the point cloud.

Clause 8: The method of any one of Clauses 1-7, wherein the point cloud of the environment is captured by at least one of a radio detection and ranging equipment or a light detection and ranging equipment.

Clause 9: The method of any one of Clauses 1-8, wherein the first plurality of points in the point cloud comprises less than a total number of points in the point cloud.

Clause 10: The method of any one of Clauses 1-9, wherein applying the deformable attention module to the coarse representation is guided by positional encodings corresponding to the first plurality of points to predict the fine sampling locations and extract fine features from the first features is guided by positional encodings corresponding tot eh first plurality of points.

Clause 11: The method of any one of Clauses 1-10, further comprising performing at least one of one or more object detection operations based on the fine representation or one or more segmentation operations based on the fine representation.

Clause 12: One or more apparatuses, comprising: one or more memories comprising executable instructions; and one or more processors configured to execute the executable instructions and cause the one or more apparatuses to perform a method in accordance with any one of Clauses 1-11.

Clause 13: One or more apparatuses, comprising: one or more memories; and one or more processors, coupled to the one or more memories, configured to cause the one or more apparatuses to perform a method in accordance with any one of Clauses 1-11.

Clause 14: One or more apparatuses, comprising: one or more memories; and one or more processors, coupled to the one or more memories, configured to perform a method in accordance with any one of Clauses 1-11.

Clause 15: One or more apparatuses, comprising means for performing a method in accordance with any one of Clauses 1-11.

Clause 16: One or more non-transitory computer-readable media comprising executable instructions that, when executed by one or more processors of one or more apparatuses, cause the one or more apparatuses to perform a method in accordance with any one of Clauses 1-11.

Clause 17: One or more computer program products embodied on one or more computer-readable storage media comprising code for performing a method in accordance with any one of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising:
one or more memories; and
one or more processors, coupled to the one or more memories, configured to cause the apparatus to:
obtain a 3D voxel image space of an environment, the 3D voxel image space comprising first features of the environment extracted from a plurality of images;
obtain a point cloud corresponding to the environment, the point cloud comprising points, wherein the points are respectively labeled with second features;
generate a coarse representation of the environment, the coarse representation comprising a projection of the first features onto the points of the point cloud, wherein the projection is based on, for each of a first plurality of points in the point cloud, combining a respective set of the first features within a first radius from a point with a respective set of the second features corresponding to the point;
apply a deformable attention module to the coarse representation to predict fine sampling locations and extract fine features from the first features; and
generate, with an attention module, a fine representation of the environment, the fine representation comprising a fusion of the fine features and the coarse representation.

2. The apparatus of claim 1, wherein to generate the coarse representation comprises to:
align a first coordinate system of the 3D voxel image space with a second coordinate system of the point cloud;
determine, for each of the first plurality of points in the point cloud, respective voxels from the 3D voxel image space within the first radius of the respective point according to the aligned first and second coordinate systems;
project, for each of the first plurality of points, the respective set of the first features corresponding to the respective voxels to the point;
aggregate, for each of the first plurality of points, the respective set of the first features to form a respective aggregated first feature vector corresponding to the point;
aggregate, for each of the first plurality of points, sets of the second features corresponding to other points of the point cloud within the first radius of the point with the second features corresponding to the point to form a respective aggregated second feature vector corresponding to the point; and
combine, for each of the first plurality of points, the respective aggregated first feature vector and the respective aggregated second feature vector to form the coarse representation.

3. The apparatus of claim 1, wherein the projection, for each of the first plurality of points, is further based on applying a respective set of aggregation weights to the respective set of the first features and combining the respective set of the first features weighted by the respective set of the aggregation weights with the respective set of the second features.

4. The apparatus of claim 3, wherein each of the respective set of the aggregation weights is learned by iteratively generating coarse representations based on different radius values for the first radius.

5. The apparatus of claim 3, wherein each of the respective set of the aggregation weights is learned by iteratively generating coarse representations based on different points forming the first plurality of points.

6. The apparatus of claim 1, wherein the one or more processors are configured to cause the apparatus to:
obtain, with a first machine learning model, the first features from the plurality of images; and
map the first features obtained from the plurality of images into the 3D voxel image space.

7. The apparatus of claim 1, wherein the one or more processors are configured to cause the apparatus to obtain, with a second machine learning model, the second features from the point cloud.

8. The apparatus of claim 1, wherein the point cloud of the environment is captured by at least one of a radio detection and ranging equipment or a light detection and ranging equipment.

9. The apparatus of claim 1, wherein the first plurality of points in the point cloud comprises less than a total number of points in the point cloud.

10. The apparatus of claim 1, wherein to apply the deformable attention module to the coarse representation is guided by positional encodings corresponding to the first plurality of points to predict the fine sampling locations and extract fine features from the first features.

11. The apparatus of claim 1, wherein the one or more processors are configured to cause the apparatus to perform at least one of one or more object detection operations based on the fine representation or one or more segmentation operations based on the fine representation.

12. A method comprising:
obtaining a 3D voxel image space of an environment, the 3D voxel image space comprising first features of the environment extracted from a plurality of images;
obtaining a point cloud corresponding to the environment, the point cloud comprising points, wherein the points are respectively labeled with second features;
generating a coarse representation of the environment, the coarse representation comprising a projection of the first features onto the points of the point cloud, wherein the projection is based on, for each of a first plurality of points in the point cloud, combining a respective set of the first features within a first radius from a point with a respective set of the second features corresponding to the point;
applying a deformable attention module to the coarse representation to predict fine sampling locations and extract fine features from the first features; and
generating, with an attention module, a fine representation of the environment, the fine representation comprising a fusion of the fine features and the coarse representation.

13. The method of claim 12, wherein generating the coarse representation comprises:
aligning a first coordinate system of the 3D voxel image space with a second coordinate system of the point cloud;
determining, for each of the first plurality of points in the point cloud, respective voxels from the 3D voxel image space within the first radius of the respective point according to the aligned first and second coordinate systems;
projecting, for each of the first plurality of points, the respective set of the first features corresponding to the respective voxels to the point; aggregating, for each of the first plurality of points, the respective set of the first features to form a respective aggregated first feature vector corresponding to the point;
aggregating, for each of the first plurality of points, sets of the second features corresponding to other points of the point cloud within the first radius of the point with the second features corresponding to the point to form a respective aggregated second feature vector corresponding to the point; and
combining, for each of the first plurality of points, the respective aggregated first feature vector and the respective aggregated second feature vector to form the coarse representation.

14. The method of claim 12, wherein the projection, for each of the first plurality of points, is further based on applying a respective set of aggregation weights to the respective set of the first features and combining the respective set of the first features weighted by the respective set of the aggregation weights with the respective set of the second features.

15. The method of claim 14, wherein each of the respective set of the aggregation weights is learned by iteratively generating coarse representations based on different radius values for the first radius.

16. The method of claim 14, wherein each of the respective set of the aggregation weights is learned by iteratively generating coarse representations based on different points forming the first plurality of points.

17. The method of claim 12, further comprising:
obtaining, with a first machine learning model, the first features from the plurality of images; and
mapping the first features obtained from the plurality of images into the 3D voxel image space.

18. The method of claim 12, further comprising obtaining, with a second machine learning model, the second features from the point cloud.

19. The method of claim 12, wherein the point cloud of the environment is captured by at least one of a radio detection and ranging equipment or a light detection and ranging equipment.

20. The method of claim 12, wherein the first plurality of points in the point cloud comprises less than a total number of points in the point cloud.
